(19) United States
(12) Patent Application Publication
(10) Pub. No.: US 2010/0262452 A1
(43) Pub. Date: Oct. 14, 2010

(54) TRACKING AND FILLING STAFFING NEEDS

(75) Inventors: Jeffrey S. Gibson, Memphis, TN (US); William Runako Godfrey, Atlanta, GA (US)

Correspondence Address: BANNER & WITCOFF, LTD., 1100 13th STREET, N.W., SUITE 1200, WASHINGTON, DC, 20005-4051, US

(73) Assignee: HEALTH CO-WORKER TECHNOLOGIES, LLC, Dallas, TX (US)

(21) Appl. No.: 12/420,930

(22) Filed: Apr. 9, 2009

(51) Int. Cl. G06Q 10/00; G06F 17/30; G06F 15/16

(52) U.S. Cl. 705/9; 709/204; 707/E17.017; 707/E17.014; 707/E17.044

(57) ABSTRACT

Staffing needs may be processed automatically by a staffing fulfillment system that determines the requirements of a staffing position, identifies personnel qualified to fill the position and notifies the identified personnel of the staffing need. A database may store personnel profiles detailing skills, qualifications and other credentials of the individual such that the fulfillment system may automatically identify individuals that are qualified to fill a need. A response from personnel may be evaluated by the system to determine whether the individual is available and willing to fill the need. The system may then fill the need if the response is positive and notify an employer that the position or need has been filled.

Aspects of the invention generally relate to filling staffing needs based on specified requirements. More specifically, aspects of the invention provide automated methods and systems for communication with qualified individuals to identify one or more qualified staffers to fill an open shift or schedule for an employer.

### BACKGROUND

In many industries, skilled personnel are needed to fill specific staffing needs. When a staffing need arises (e.g., if a currently scheduled staff member falls ill), the opening needs to be filled by someone with the requisite skills, qualifications, certifications, licenses and/or time. Using current methods, staffing needs and finding individuals that satisfy those staffing needs are evaluated manually. Those individuals are then contacted by tradition phone (POTS) by, e.g., a staffing agency, to determine whether each individual is available to fill the need. The use of a staffing agency and the manual processes involved in filling a need increases costs and reduces efficiency.

### BRIEF SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

According to aspects of the present disclosure, a staffing need or open position may be filled by automatically identifying individuals that satisfy various requirements of the need or position. For example, a staffing need may require an individual to have a nursing license and thus, only those with a nursing license should be contacted about the availability of the opening. A fulfillment system may query a database storing profiles of potential personnel to identify those that are qualified to fill the need. Once identified, the individuals may be contacted in various manners such as text message, multimedia message, voicemail, telephone call, e-mail and the like. An individual may then respond to the notification of the opening with a positive or negative response. In some instances, any response is treated as a positive response while no response is considered a negative response. A positively-responding individual may be selected on a first come-first serve basis or using other selection methods.

According to another aspect, a staffing need may be defined using optional credentials. That is, a staffing need may list optional skills, certifications or licenses that would be preferred, but not required for someone to fill a position. In such configurations, an individual may be selected to fill a need based on a number of optional or preferred credentials belonging to the individual.

According to yet another aspect, a fulfillment system may store personnel schedules in a database. Thus, the fulfillment system may be able to automatically determine whether an individual is available to fill a need based on whether their schedules are open during the time period specified by the need.

### BRIEF DESCRIPTION OF THE DRAWINGS

Certain embodiments are illustrated by way of example and not limited in the accompanying figures in which like reference numerals indicate similar elements and in which:

FIG. 1 illustrates a block diagram of an example communication network in which one or more embodiments may be implemented.

FIG. 2 illustrates a method for registering a staffing need and identifying an individual qualified to the fill the need according to one or more aspects described herein.

FIGS. 3A-C illustrate notification and response messaging interfaces for processing staffing needs according to one or more aspects described herein.

FIG. 4 illustrates a method for monitoring and obtaining updated credential information according to one or more aspects described herein.

FIG. 5 illustrates a staffing need registration interface according to one or more aspects described herein.

FIG. 6 illustrates an interface for listing pending, completed, expired and/or cancelled needs or positions according to one or more aspects described herein.

FIG. 7 illustrates a block diagram of a staffing fulfillment system according to one or more aspects described herein.

### DETAILED DESCRIPTION

In the following description of the various embodiments, reference is made to the accompanying drawings, which form a part hereof, and in which are shown by way of illustration various embodiments in which the invention may be practiced. It is to be understood that other embodiments may be utilized and structural and functional modifications may be made without departing from the scope of the present invention.

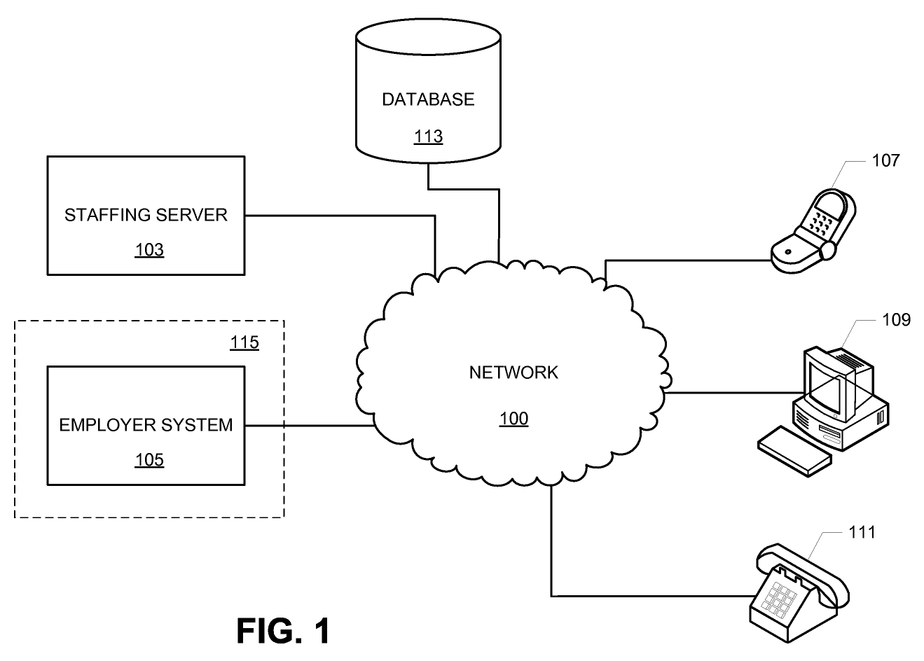

FIG. 1 illustrates a block diagram of an example network environment in which staffing needs may be filled by transmitting notifications to qualified personnel. Network 100 facilitates communication between staffing server 103, employer systems 105, personnel devices 107, 109 and 111 and database 113. Personnel device 107 includes any mobile communication device such as, but not limited to, a cell phone, smartphone, personal data assistant (PDA) and the like. Personnel device 109 comprises a computer (e.g., a PC) while personnel device 111 comprises another telecommunication device such as a landline telephone. Other devices may be used in place of or in addition to the personnel devices 107, 109 and 111. Personnel devices 107, 109 and 111 may be configured to receive notifications, calls and other messages from other devices including staffing server 103 through network 100. To facilitate such communications, network 100 may support a variety of protocols and wired and wireless type connections. For example, network 100 may include support for cellular communication protocols, wireless communication protocols conforming to IEEE 802.11 standards, wired or wireless local area network (LAN) protocols, satellite communication links and protocols and the like. Additionally or alternatively, network 100 may support various messaging protocols including short message services (SMS), multimedia message services (MMS), plain old telephone service (POTS), electronic mail (e-mail), voice over Internet Protocol (VOIP), voicemail, instant messaging protocols and the like.

Staffing server 103 is configured to receive staffing requests from one or more employers such as employer 115. An employee, for example, may transmit staffing requests to server 103 via one or more employer systems 105 and network 100. In one or more configurations, staffing server 103 may be remote from employer 115 and systems 105. In other configurations, staffing server 103 may be a device local to employer 115. Additionally or alternatively, staffing server 103 may be configured to serve multiple employers or organizations. Database 113 may include personnel information such as certifications, licensures, work preferences (e.g., preferred hours, locations, departments) and skill set information for each individual. Database 113 may also store and track employment information of each individual such as past positions filled, hours worked by the individual per week, upcoming positions scheduled to be filled by the individual and the like. Accordingly, staffing server 103 may draw information from database 113 to fill staffing requests received from employers such as employer 115. Database 113 may also be accessible by employer systems 105.

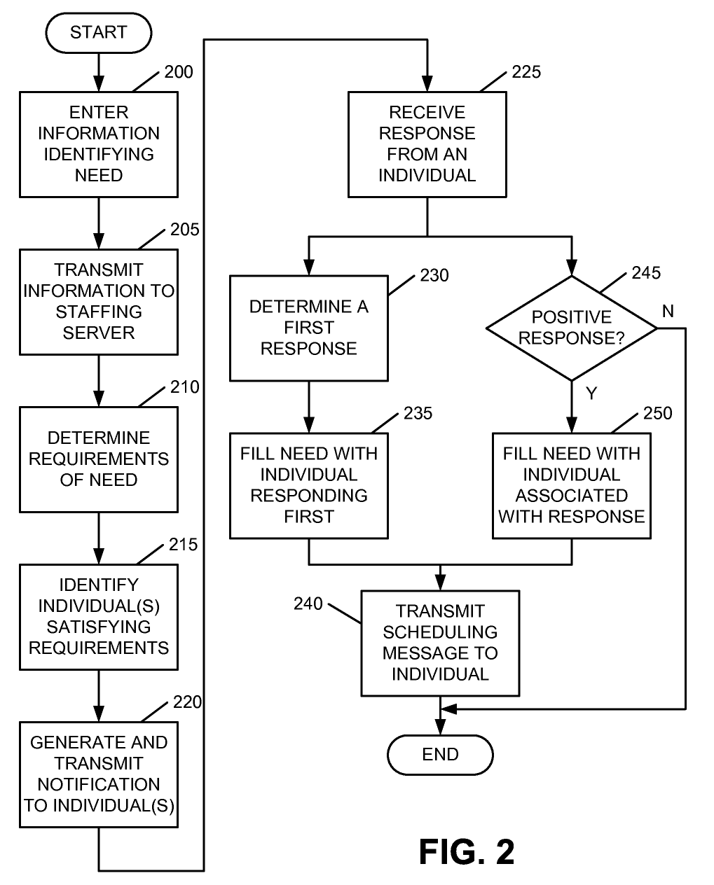

FIG. 2 illustrates a process flow for registering a staffing need and identifying personnel qualified to fill the need. In step 200, an employer may enter information identifying a staffing need. The information may include required licenses, certifications, or other qualifications, an amount of time needed, the time and day of the need, a maximum or other threshold cost of the personnel, number of individuals or man-hours needed, and the like. A cost requirement may indicate a maximum amount an employer is willing to pay for the fill the staffing need. The cost requirement may be specified in a hourly wage format, a total cost value, a per person cost and the like. In step 205, the staffing need may be transmitted to a staffing fulfillment system. Upon receipt, the staffing fulfillment server may identify or otherwise determine the requirements of the need in step 210. Once the need requirements and/or qualifications have been determined by the fulfillment server, the server may identify one or more individuals that meet the specified requirements in step 215. Various algorithms may be used to query/search through a database of individuals and to filter out those that do not satisfy the requirements of the staffing need. In one example, the fulfillment server may initially filter entries in the database using a first requirement to generate a set of individuals satisfying the first requirement and subsequently filter the set using a second requirement and so on. According to one or more arrangements, the fulfillment server may store personnel schedules such that individuals may further be filtered based not only on qualifications but also on schedule availability.

Once the fulfillment server has identified one or more qualified individuals, the fulfillment server may generate and transmit a notification to each of the identified individuals qualified to fill the staffing need in step 220. The notification may conform to various messaging protocols such as SMS, MMS, e-mail and the like. In one example, the fulfillment server may generate a message and transmit the message by e-mail to an SMS server. For example, the message may be sent to 5555555555@messaging.abcwireless.com, where 555-555-5555 is the recipient's phone number and messaging.abcwireless.com is the address of the SMS server for ABC Wireless Co. The SMS server may then transmit the message as an SMS message to the designated recipient's device. In some embodiments, a user's device may include an application programming interface (API) to process messages and responses to the messages.

In step 225, the fulfillment server may receive a response to the notification from one or more qualified individuals. Responses may be processed in a variety of ways. According to one embodiment, any response may be regarded as a positive response. According to another embodiment, the received responses are individually parsed or analyzed to determine whether each response is a positive response or a negative response. In the former configuration, the fulfillment server may determine which response was received first in step 230 if multiple responses were received. Responses may, for example, be time stamped by a messaging server or by the fulfillment server upon receipt. The fulfillment server may then fill the staffing need with the individual that responded first in step 235. Filling the staffing need may include transmitting a message to the employer or organization registering the need identifying the individual that is scheduled to fill the need. Alternatively, the fulfillment server may wait a predetermined amount of time or may wait until a predetermined time of day, and then analyze all received responses to determine which individual(s) best match the staffing need, or to determine which individual has a highest priority or rank as compared to the other respondents. In step 240, the fulfillment server may further transmit a scheduling message to the first or otherwise selected individual to respond confirming that he or she will be filling the registered need. Optionally, the fulfillment server may transmit a further message to the other qualified individuals indicating that the need has been filled.

In an alternate configuration, the fulfillment server may use various parsing algorithms to determine whether a response is positive or negative in step 245. For example, the fulfillment server may use a parsing tool that looks for words such as ‘Y’, ‘yes’ or ‘available’ for a positive response and ‘N’, ‘no’ or ‘reject’ as a negative answer. In other configurations, natural language processors may be used to evaluate natural language expressions to determine a positive or negative meaning. In step 250, the fulfillment server may fill the staffing need with the individual submitting the first positive response. As discussed, the responses may be time stamped or otherwise time-designated to help the fulfillment server determine an order in which the responses were received. The fulfillment server may then transmit a scheduling message to the selected individual in step 240.

According to one or more aspects, an individual may be selected to fill a position or need based on factors other than or in addition to an order in which a positive response was received. In one example, as alluded to above, parameters defining a staffing need may include optional or preferred qualifications in addition to mandatory requirements. While the mandatory requirements are used to determine if an individual is even notified of the staffing need, the optional or preferred qualifications may be used to rank the individuals that do meet the mandatory requirements. Accordingly, an individual that satisfies 4 out of 5 preferred or optional qualifications may be selected to fill a need over another individual that only satisfies 2 out of the 5 preferred or optional qualifications. Other factors may also be considered in selecting someone to fill a need, including seniority, number of hours worked (e.g., those having worked less in the past week may be selected over individuals that have worked more), historical reliability, and the like.

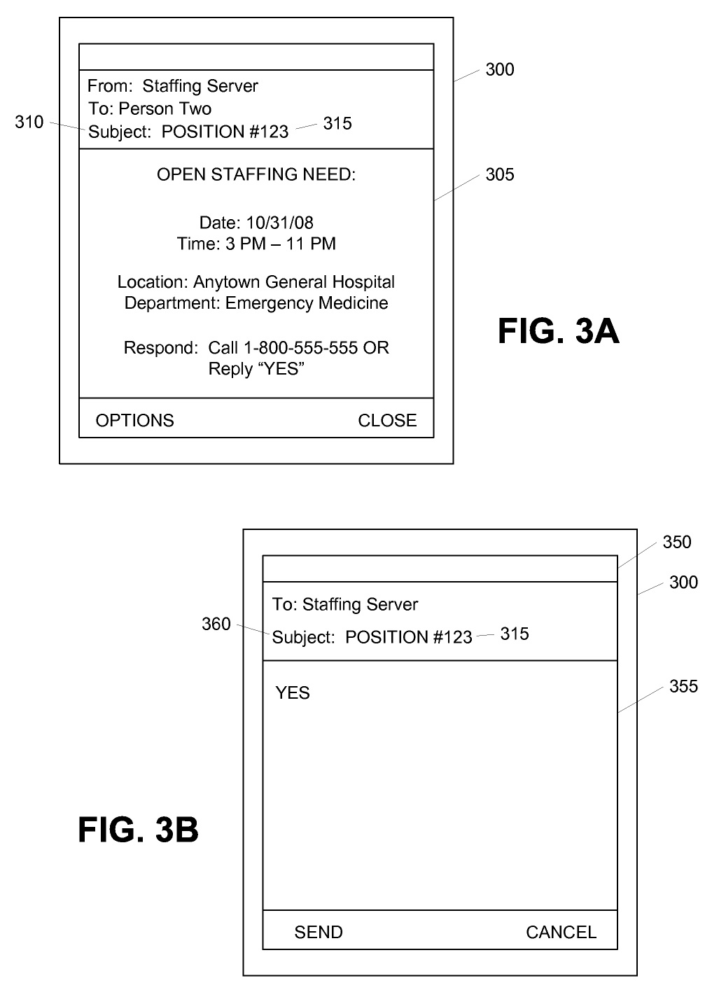

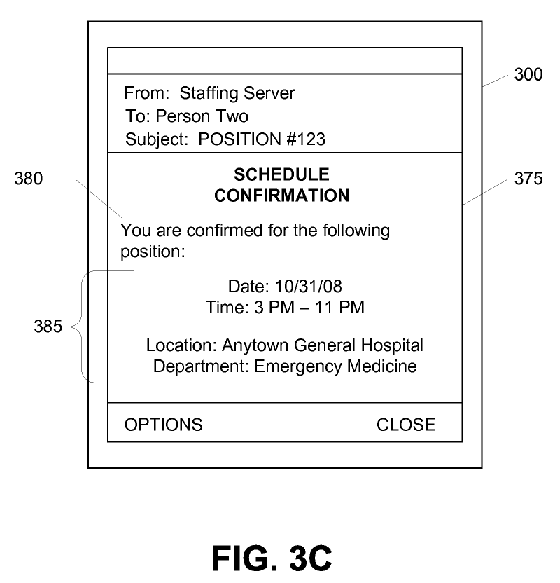

FIGS. 3A and 3B illustrate a series of message interfaces in which a notification of a staffing need is received and a positive response is created. In FIG. 3A, for example, device 300 may display notification message 305 indicating the existence of a staffing need in the Emergency Medicine Department of Anytown General Hospital on October 31 between the hours of 3 PM and 11 PM. Notification message 305 may further provide instructions and/or indicate a method in which to respond. Specifically, message 305 indicates that to indicate a desire to fill the need, a user may respond with the word “yes” or by calling a staffing number (i.e., 1-800-555-5555). Message subject 310 may include a staffing need reference number 315 (in this example, #123).

FIG. 3B illustrates a subsequent messaging interface 350 in which a user has prepared a response 355 indicating availability and a desire to fill the staffing need. The response 355 is in the form of a text message replying to the source of notification message 305 of FIG. 3A. Response 355 includes the word “yes” indicating that the user is available and would like to fill the indicated need. The staffing need reference number 315 is included in the subject line 360 for identification purposes.

In response to the user's indication of availability, the user may receive a confirmation message 375, as illustrated in FIG. 3C. The confirmation message 375 may include an indication or message 380 that the user is scheduled to fill the need and a re-listing 385 of the need.

In order to determine whether an individual is a qualified for a position or need, a fulfillment server or scheduler may use credential and licensure information. Thus, a nursing position may require someone filling the need to have a nursing license. As discussed, licensure and credential information may be stored and maintained in a database. Additionally, a monitoring system or tool may be used to ensure that licensure and credential data is up to date. For example, the monitoring system or tool may periodically, sporadically, or aperiodically examine the expiration dates of licenses and other certifications or credentials of each individual in the database to insure that the license or certification is still effective.

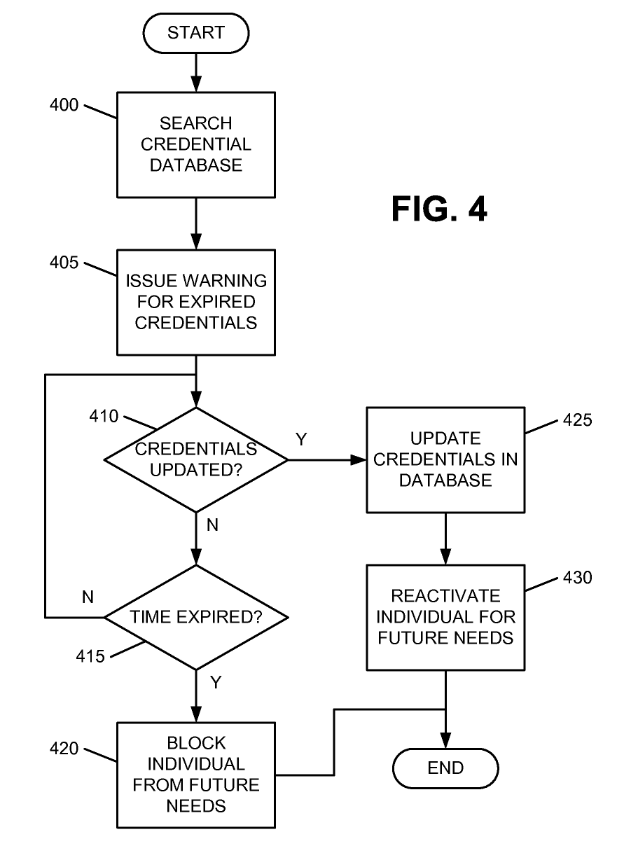

FIG. 4 illustrates a method for monitoring credential information and requesting updated data. In step 400, a credential monitor may search through a credential database to determine whether a credential has expired or is otherwise invalid. Such a determination may be made by storing credential expiration dates and comparing the dates with a current date. If a credential has expired, the credential monitor may issue a warning message or other notification to the individual associated with the credential of the expiration in step 405. The notification or warning may include a request to update the credential and information regarding how the credential may be updated. The credential monitor may give the individual a predefined amount of time (e.g., 24 hours) in which to provide updated credentials before being blocked from staffing need notifications requiring the expired credential or staffing need notifications in general. In step 410, the credential monitor may determine whether updated credential information has been received. If not, the credential monitor may determine whether the predefined amount of time has expired in step 415. If the predefined amount of time has expired, the credential monitor may instruct the fulfillment server to block the individual associated with the expired credential from being notified about new staffing needs in step 420.

If, on the other hand, updated credential information has been received, the credential monitor may update the individual's profile with the new information in step 425. Optionally, if the individual's profile has been deactivated, the credential monitor may reactivate the individual for filling staffing needs in step 430.

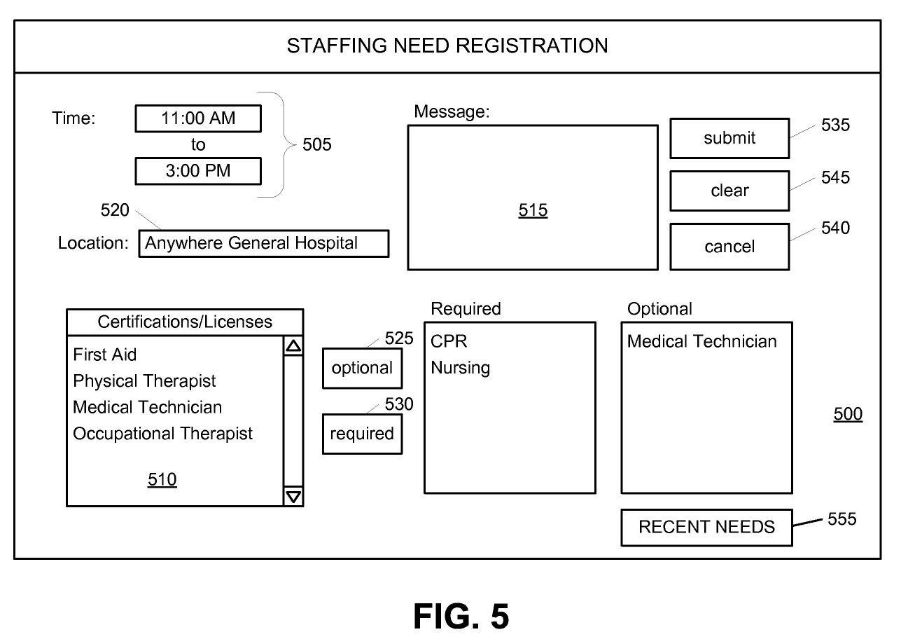

FIG. 5 illustrates a user interface for registering a staffing need. Interface 500 includes a variety of information fields 505, 510, 515 and 520 for defining the staffing need. For example, information field 505 may be configured to define a staffing need time and/or date. Information field 510 may provide a selectable menu of credentials, licensures, other official certifications or skills that are required for the staffing need. In some instances, the credentials may be specified as required or optional using options 525 and 530. Field 515 may be used to enter a specific message that is to be transmitted to individuals that could potentially fill the need. Field 520 may be configured to receive location information for the staffing need. In some instances, field 520 may be automatically populated if the interface 500 is being used from a particular location. Once the staffing need information has been entered, a user may select submit option 535 to forward the information to a fulfillment system. Other options included in interface 500 are cancel option 540 that exits out of interface 500 without submitting a staffing need and clear option 545 that allows a user to clear all data entered in interface 500.

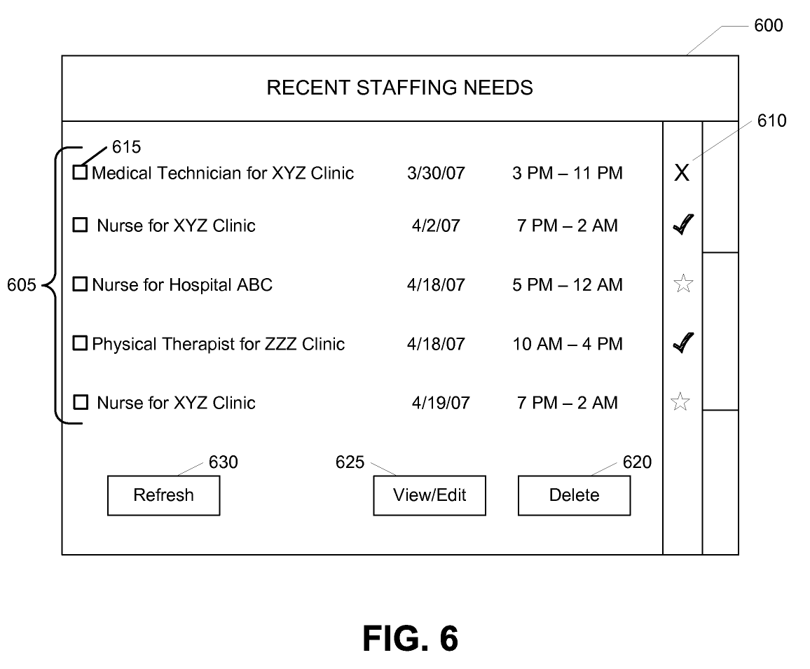

In one or more arrangements, interface 500 may further include a recent needs listing option 555 that displays all staffing needs submitted within a predefined period (e.g., the past 24 hours). FIG. 6 illustrates a needs listing interface 600 that, in addition to displaying a list 605 of staffing needs submitted, provides the status 610 of each of those staffing needs. The status of each need may be represented by a symbol such as a star for pending, a check mark for filled and an ‘X’ for expired/unfilled. Additionally or alternatively, a user may perform various actions upon each need by selecting the needs to be acted upon using selection boxes 615 and choosing an option such as delete 620 and edit 625. Listing interface 600 may automatically update (e.g., refresh every 30 seconds or upon receipt of new data) or may be manually updated using manual refresh option 630.

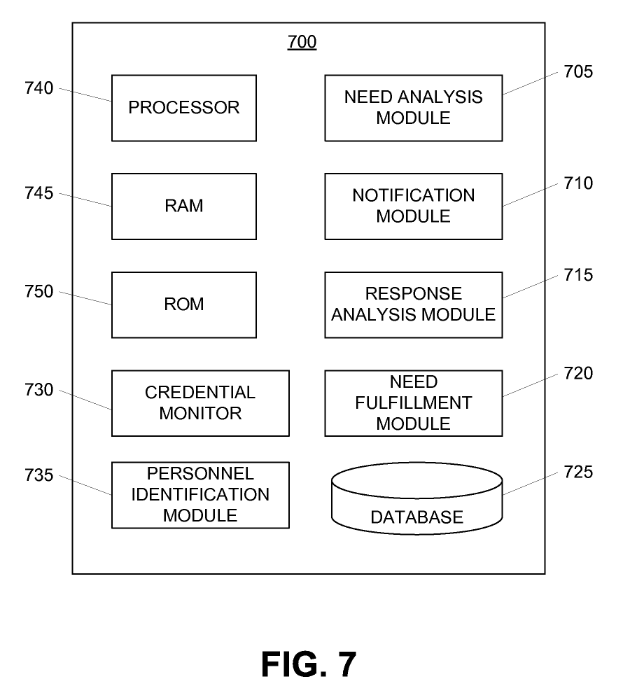

FIG. 7 illustrates a block diagram representing an illustrative system architecture of a fulfillment system. System 700 includes various components including a need analysis module 705, a notification module 710, a response analysis module 715, need fulfillment module 720, database 725, credential monitor 730, personnel identification module 735, processor 740 and random access memory (RAM) 745 and read-only memory (ROM) 750. Processor 740 is generally configured to execute instructions such as computer programs and may be used by one or more of modules 705, 710, 715, 720, 730 and 735 to perform one or more calculations. Such instructions may be stored in RAM 745 or ROM 750. Need analysis module 705 may be configured to receive and process a staffing need request including determining the staffing need requirements and specifications. Staffing need information may then be fed into personnel identification module 735 to generate a set of individuals that meet the staffing need requirements. In one example, database 725 may store profiles of professionals that may be called upon to fill needs. Notification module 710 may generate and transmit a message including information about the staffing need to the individuals identified by personnel identification module 735. If a response is received from one or more of the notified individuals, response analysis module 715 may analyze the response to determine whether or not the individual is available to fill the need. If available, the need fulfillment module 720 may be configured to assign the individual to the staffing need and to notify the employer that the need has been filled.

The aspects described herein may also be applied or used for other types of resources. For example, a car rental service may issue a reservation request to multiple cars in its fleet. The cars may include some semi-autonomous device or computing system that may be aware of the car's schedule and availability. Each car's device may response to the reservation request to indicate its availability to fill the reservation. The car rental service might only issue the reservation request to cars that satisfy a customer's specified requirements such as 4 doors, power locks/windows, CD player or changer, four wheel drive, V6 engine, minimum gas mileage, a maximum cost and the like.

It should be understood that any of the method steps, procedures or functions described herein may be implemented using one or more processors in combination with executable instructions that cause the processors and other components to perform the method steps, procedures or functions. As used herein, the terms “processor” and “computer” whether used alone or in combination with executable instructions stored in a memory or other computer-readable storage medium should be understood to encompass any type of now known or later developed computing devices and/or structures including but not limited to one or more microprocessors, special-purpose computer chips, field-programmable gate arrays (FPGAs), controllers, application-specific integrated circuits (ASICs), combinations of hardware/firmware/software, or other special or general-purpose processing circuitry.

The methods and features recited herein may further be implemented through any number of computer readable media that are able to store computer readable instructions. Examples of computer readable media that may be used include RAM, ROM, EEPROM, flash memory or other memory technology, CD-ROM, DVD or other optical disk storage, magnetic cassettes, magnetic tape, magnetic storage and the like.

Although specific examples of carrying out the invention have been described, those skilled in the art will appreciate that there are numerous variations and permutations of the above-described systems and methods that are contained within the spirit and scope of the invention as set forth in the appended claims. Additionally, numerous other embodiments, modifications and variations within the scope and spirit of the appended claims will occur to persons of ordinary skill in the art from a review of this disclosure.

What is claimed is:

1. A method comprising:
receiving, at a needs fulfillment server, registration of a staffing need from an employer;
determining, at the needs fulfillment server, a requirement to fill the staffing need, wherein the requirement is specified in the received registration;
querying, by the needs fulfillment server, a personnel database using the determined requirement to identify a plurality of individuals qualified to fill the staffing need;
transmitting, from the needs fulfillment server to each of the plurality of qualified individuals, a notification message regarding the staffing need;
receiving an affirmative response from each of the plurality of individuals, the affirmative response indicating a desire to fill the staffing need;
selecting an individual to fill the staffing need from the plurality of individuals using a priority algorithm;
confirming fulfillment of the staffing need with the selected individual; and
notifying the employer of the individual selected to fill the staffing need.

2. The method of claim 1, wherein the priority algorithm comprises selecting the individual based on the individual first responding to the notification message.

3. The method of claim 1, wherein the priority algorithm comprises selecting the individual based on an amount of experience.

4. The method of claim 1, wherein the priority algorithm comprises selecting the individual based on a number of optional criteria for filling the staffing need met by the individual.

5. A method comprising:
determining, at a computing device, a requirement to fill a staffing need of an employer;
automatically identifying, by the computing device, an individual qualified to fill the staffing need based on the determined requirement; and
notifying, by the computing device, the individual of the staffing need.

6. The method of claim 5, wherein the requirement includes possession of a skill needed to fill the staffing need.

7. The method of claim 5, wherein automatically identifying the individual qualified to fill the staffing need includes identifying a plurality of individuals qualified to the fill the staffing need and wherein notifying the individual of the staffing need includes notifying each of the plurality of individuals of the staffing need.

8. The method of claim 7, further comprising:
receiving a response from at least one of the plurality of individuals; and
automatically filling the staffing need with the at least one of the plurality of individuals.

9. The method of claim 7, further comprising:
receiving a plurality of responses from the plurality of individuals;
selecting one of the plurality of individuals based on a priority algorithm; and
automatically filling the staffing need with the selected one of the plurality of individuals.

10. The method of claim 9, wherein the priority algorithm comprises selecting the one of the plurality of individuals based on an amount of experience.

11. The method of claim 9, wherein the priority algorithm comprises selecting the one of the plurality of individuals based on a number of optional criteria for filling the staffing need met by the selected one of the plurality of individuals.

12. The method of claim 5, further comprising:
determining whether the individual responded positively to the notification; and
filling the staffing need with the individual in response to determining that the individual responded positively to the notification.

13. The method of claim 5, further comprising determining whether the individual is available during a time period corresponding to the staffing need.

14. The method of claim 5, wherein the notification includes a text message.

15. The method of claim 5, wherein the notification includes an electronic mail message.

16. The method of claim 5, wherein the requirement includes possession of a license or certification.

17. The method of claim 6, wherein the requirement includes a cost of the personnel.

18. A method comprising:
notifying, by a computing device, an individual of a staffing need, wherein the individual satisfies a requirement to fill the staffing need;
receiving, at the computing device, a response from the individual;
determining, by the computing device, whether the response indicates a desire to fill the staffing need; and
in response to determining that the response indicates a desire to fill the staffing need, notifying, by the computing device, an employer of an availability of the individual to fill the staffing need.

19. The method of claim 18, wherein the requirement includes a skill needed to fill the staffing need.

20. The method of claim 18, further comprising automatically identifying the individual satisfying the requirement to fill the staffing need.

21. The method of claim 20, wherein automatically identifying the individual satisfying the requirement to fill the staffing need includes filtering a database of a plurality of individuals based on the requirement to fill the staffing need.

22. The method of claim 18, wherein determining whether the response indicates a desire to fill the staffing need includes parsing the response to determine whether a specified word is included in the response.

23. One or more computer readable media storing computer readable instructions that, when executed, cause an apparatus to perform a method comprising:
determining, at the apparatus, a requirement to fill a staffing need of an employer;
automatically identifying, by the apparatus, an individual qualified to fill the staffing need based on the determined requirement; and
notifying, by the apparatus, the individual of the staffing need.

24. The one or more computer readable media of claim 23, wherein automatically identifying the individual qualified to fill the staffing need includes identifying a plurality of individuals qualified to the fill the staffing need and wherein notifying the individual of the staffing need includes notifying each of the plurality of individuals of the staffing need.

25. The one or more computer readable media of claim 24, further comprising instructions for:
receiving a response from at least one of the plurality of individuals; and
automatically filling the staffing need with the at least one of the plurality of individuals.

26. The one or more computer readable media of claim 24, further comprising instructions for:
receiving a plurality of responses from the plurality of individuals;
selecting one of the plurality of individuals based on a priority algorithm; and
automatically filling the staffing need with the selected one of the plurality of individuals.

27. The one or more computer readable media of claim 26, wherein the priority algorithm comprises selecting the one of the plurality of individuals based on an amount of experience.

28. The one or more computer readable media of claim 26, wherein the priority algorithm comprises selecting the one of the plurality of individuals based on a number of optional criteria for filling the staffing need met by the selected one of the plurality of individuals.
